(19) United States
(12) Patent Application Publication
(10) Pub. No.: US 2017/0069075 A1
(43) Pub. Date: Mar. 9, 2017

(54) CLASSIFIER GENERATION APPARATUS, DEFECTIVE/NON-DEFECTIVE DETERMINATION METHOD, AND PROGRAM

(71) Applicant: CANON KABUSHIKI KAISHA, Tokyo (JP)

(72) Inventor: Hiroshi Okuda, Utsunomiya-shi (JP)

(21) Appl. No.: 15/232,700

(22) Filed: Aug. 9, 2016

(30) Foreign Application Priority Data
Sep. 4, 2015 (JP) 2015-174899
Mar. 28, 2016 (JP) 2016-064128

(51) Int. Cl. G06T 7/00; G06K 9/52; G06T 11/60; G06K 9/62; G06K 9/66

(52) U.S. Cl. CPC G06T 7/0004; G06K 9/6267; G06K 9/66; G06T 11/60; G06K 9/52; G06T 2207/30148; G06T 2207/20081

(57) ABSTRACT

In order to determine whether an appearance of an inspection target object is defective or non-defective, a classifier generation apparatus extracts feature amounts from each of at least two images based on images captured under at least two different imaging conditions with respect to a target object having a known defective or non-defective appearance. The classifier generation apparatus selects a feature amount for determining whether the target object is defective or non-defective from feature amounts that comprehensively include the extracted feature amounts, and generates a classifier for determining whether the target object is defective or non-defective based on the selected feature amount. The determination whether appearance of the target object is defective or non-defective is based on the extracted feature amount and the classifier.

### BACKGROUND

Field

Aspects of the present invention generally relate to a classifier generation apparatus, a defective/non-defective determination method, and a program, and particularly, to determining whether an object is defective or non-defective based on a captured image of the object.

Description of the Related Art

Generally, a product manufactured in a factory is inspected and it is determined whether the product is defective or non-defective based on its appearance. If it is previously known how defects (i.e., defects in strength, sizes, and positions) appear in a defective product, a method can be provided to detect the defects of an inspection target object based on a result of image processing executed on a captured image of the inspection target object. However, in many cases, defects appear in an indefinite manner, and defects in strength, sizes, and positions may vary in many ways. Accordingly, conventionally, appearance inspection is visually carried out, while automated appearance inspection is hardly put into the practical use.

An inspection method using a large number of feature amounts is known that automates the inspection with respect to the indefinite defects. Specifically, images of a plurality of non-defective and defective products are captured as learning samples. That is, a large number of feature amounts, such as an average, a dispersion, a maximum value, and a contrast of a pixel value are extracted from these images, and a classifier for classifying non-defective and defective products is created in a multidimensional feature amount space. Then, this classifier is used to determine whether an actual inspection target object is a non-defective product or a defective product.

If the number of feature amounts relative to the number of learning samples is increased, the classifier excessively fits into the learning samples of non-defective and defective products in a learning period (i.e., overfitting), and thus issues such as generalization errors increase with respect to the inspection target object. A redundant feature amount can be included if the number of feature amounts is increased, and thus processing time required for learning can increase. Therefore, it is desirable to employ a method capable of accelerating the arithmetic processing by reducing the generalization errors by selecting appropriate feature amounts from among a large number of feature amounts. According to a technique discussed in Japanese Patent Application Laid-Open No. 2005-309878, a plurality of feature amounts is extracted from a reference image, and feature amounts used for determining an inspection image are selected from the plurality of extracted feature amounts. Then, it is determined whether the inspection target object is non-defective or defective from the inspection image based on the selected feature amounts.

One method for inspecting and classifying the defects with higher sensitivity includes inspecting the inspection target object by capturing images of the inspection target object under a plurality of imaging conditions. According to a technique discussed in Japanese Patent Application Laid-Open No. 2014-149177, images are acquired under a plurality of imaging conditions, and partial images that include defect candidates are extracted under the imaging conditions. Then, the feature amounts of the defect candidates in the partial images are acquired, so that defects are extracted from the defect candidates based on the feature amounts of the defect candidates having the same coordinates with different imaging conditions.

Generally, imaging condition (e.g., illumination method) and a defect type are related to each other, so that different defects are visualized under different imaging conditions. Accordingly, to determine whether the inspection target object is defective or non-defective with high precision, the inspection is executed by capturing the images of the inspection target object under a plurality of imaging conditions and visualizing the defects more clearly. However, in the technique described in Japanese Patent Application Laid-Open No. 2005-309878, images are not captured under a plurality of imaging conditions. Therefore, it is difficult to determine with a high degree of accuracy whether the inspection target object is defective or non-defective. Further, in the technique described in Japanese Patent Application Laid-Open No. 2014-149177, although the images are captured under a plurality of imaging conditions, the above-described feature amounts useful for separating between non-defective products and defective products are not selected. In a case where the techniques described in Japanese Patent Application Laid-Open Nos. 2005-309878 and 2014-149177 are combined together, inspection is be executed by capturing the images under a plurality of imaging conditions, and thus the inspection is executed as many times as the number of the imaging conditions. Therefore, the inspection time increases. Because different defects are visualized under different imaging conditions, learning target images have to be selected for each of the imaging conditions. In addition, if it is difficult to select the learning target images because of a visualization state of the defect, a redundant feature amount can be selected when the feature amounts are to be selected. Accordingly, this can cause both increased inspection time and degradation of the performance for separating between defective products and non-defective products.

### SUMMARY

According to an aspect of the present invention, a classifier generation apparatus includes a learning extraction unit configured to extract a plurality of feature amounts of images from each of at least two images based on images captured under at least two different imaging conditions with respect to a target object having a known defective or non-defective appearance, a selection unit configured to select a feature amount for determining whether a target object is defective or non-defective from among the extracted feature amounts, and a generation unit configured to generate a classifier for determining whether a target object is defective or non-defective based on the selected feature amount. (note: if the proposed defective/non-defective apparatus claim is added, it is recommended that the above paragraph be replaced with the following:

A defective/non-defective determination apparatus includes a learning extraction unit configured to extract feature amounts from each of at least two images based on images captured under at least two different imaging conditions with respect to a target object having a known defective or non-defective appearance, a selection unit configured to select a feature amount for determining whether a target object is defective or non-defective from among the extracted feature amounts, a generation unit configured to generate a classifier for determining whether a target object is defective or non-defective based on the selected feature amount, an inspection extraction unit configured to extract feature amounts from each of at least two images based on images captured under the at least two different imaging conditions with respect to a target object having an unknown defective or non-defective appearance, and a determination unit configured to determine whether an appearance of the target object is defective or non-defective by comparing the extracted feature amounts with the generated classifier.

Further features of aspects of the present invention will become apparent from the following description of exemplary embodiments with reference to the attached drawings.

### BRIEF DESCRIPTION OF THE DRAWINGS

FIG. 1 is a block diagram illustrating a hardware configuration in which a defective/non-defective determination apparatus is implemented.

FIG. 2 is a block diagram illustrating a functional configuration of the defective/non-defective determination apparatus.

FIG. 3A is a flowchart illustrating processing executed by the defective/non-defective determination apparatus in a learning period.

FIG. 3B is a flowchart illustrating processing executed by the defective/non-defective determination apparatus in an inspection period.

FIGS. 4A and 4B are diagrams illustrating a first example of a relationship between an imaging apparatus and a target object.

FIG. 5 is a diagram illustrating examples of illumination conditions.

FIG. 6 is a diagram illustrating images of a defective portion captured under respective illumination conditions.

FIG. 7 is a diagram illustrating a configuration of a learning target image.

FIG. 8 is a diagram illustrating a creation method of a pyramid hierarchy image.

FIG. 9 is a diagram illustrating pixel numbers for describing wavelet transformation.

FIG. 10 is a diagram illustrating a calculation method of a feature amount that emphasizes a scratch defect.

FIG. 11 is a diagram illustrating a calculation method of a feature amount that emphasizes an unevenness defect.

FIG. 12 is a table illustrating a list of feature amounts.

FIG. 13 is a table illustrating a list of combined feature amounts.

FIGS. 14A and 14B are diagrams illustrating operation flows with or without using the combined feature amounts.

FIGS. 15A and 15B are diagrams illustrating a second example of a relationship between an imaging apparatus and a target object.

FIG. 16 is a diagram illustrating a relationship between the imaging apparatus and the target object illustrated in FIG. 15A (15B) in three dimensions.

FIGS. 17A and 17B are diagrams illustrating a third example of a relationship between an imaging apparatus and a target object.

FIGS. 18A and 18B are diagrams illustrating a fourth example of a relationship between an imaging apparatus and a target object.

FIG. 19 is a diagram illustrating a fifth example of a relationship between an imaging apparatus and a target object.

FIG. 20 a diagram illustrating a sixth example of a relationship between an imaging apparatus and a target object.

### DESCRIPTION OF THE EMBODIMENTS

Hereinafter, a plurality of exemplary embodiments will be described with reference to the appended drawings. In each of below-described exemplary embodiments, learning and inspection will be executed by using image data of a target object captured under at least two different imaging conditions. For example, the imaging conditions include at least any one of a condition relating to an imaging apparatus, a condition relating to a surrounding environment of the imaging apparatus in the imaging-capturing period, and a condition relating to a target object. In a first exemplary embodiment, capturing the images of a target object under at least two different illumination conditions will be employed as a first example of the imaging condition. In a second exemplary embodiment, capturing the images of a target object by at least two different imaging units will be employed as a second example of the imaging condition. In a third exemplary embodiment, capturing at least two different regions in a target object in a same image will be employed as a third example of the imaging condition. In a fourth exemplary embodiment, capturing the images of at least two different portions of a same target object will be employed as a fourth example of the imaging condition.

First, a first exemplary embodiment will be described.

In the present exemplary embodiment, firstly, examples of a hardware configuration and a functional configuration of a defective/non-defective determination apparatus will be described. Then, respective flowcharts (steps) of learning and inspection processing will be described. Lastly, an effect of the present exemplary embodiment will be described.

### <Hardware Configuration and Functional Configuration>

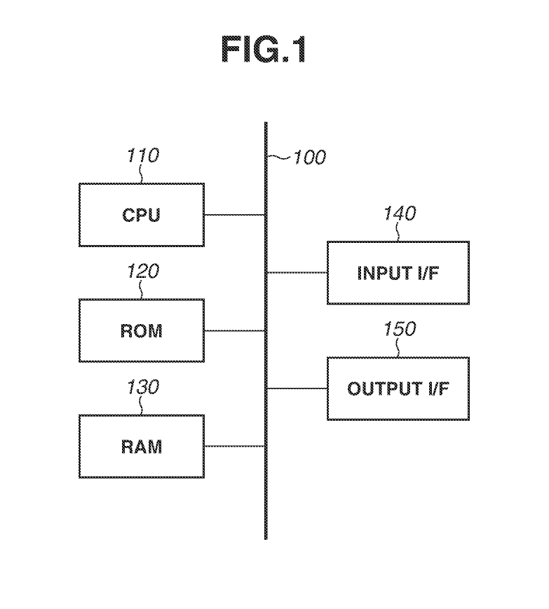

An example of a hardware configuration to which a defective/non-defective determination apparatus according to the present exemplary embodiment is implemented is illustrated in FIG. 1. In FIG. 1, a central processing unit (CPU) 110 generally controls respective devices connected thereto via a bus 100. The CPU 110 reads and executes a processing step or a program stored in a read only memory (ROM) 120. Various processing programs or device drivers according to the present exemplary embodiment, including an operating system (OS), are stored in the ROM 120, so as to be executed by the CPU 110 as appropriate by storing them in a random access memory (RAM) 130 temporarily. An input interface (I/F) 140 receives an input signal from an external apparatus such as an imaging apparatus in a format processible by the defective/non-defective determination apparatus. Further, an output I/F 150 outputs an output signal in a format processible by an external apparatus such as a display apparatus.

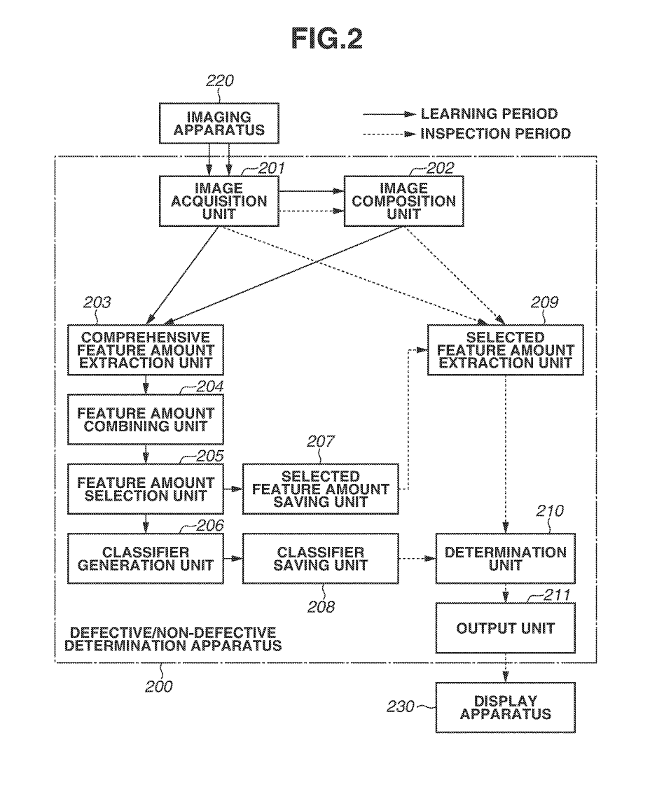

FIG. 2 is a block diagram illustrating an example of a functional configuration of the defective/non-defective determination apparatus according to the present exemplary embodiment. In FIG. 2, a defective/non-defective determination apparatus 200 according to the present exemplary embodiment includes an image acquisition unit 201, an image composition unit 202, a comprehensive feature amount extraction unit 203, a feature amount combining unit 204, a feature amount selection unit 205, a classifier generation unit 206, a selected feature amount saving unit 207, and a classifier saving unit 208. The defective/non-defective determination apparatus 200 further includes a selected feature amount extraction unit 209, a determination unit 210, and an output unit 211. Further, the defective/non-defective determination apparatus 200 is connected to an imaging apparatus 220 and a display apparatus 230. The defective/non-defective determination apparatus 200 creates a classifier by executing machine learning on an inspection target object known as a defective or non-defective product, and determines whether an appearance is defective or non-defective with respect to an inspection target object that is not known as a defective or non-defective product by using the created classifier. In FIG. 2, an operation order in the learning period is indicated by solid arrows whereas an operation order in the inspection period is indicated by dashed arrows.

The image acquisition unit 201 acquires an image from the imaging apparatus 220. In the present exemplary embodiment, the imaging apparatus 220 captures images under at least two or more illumination conditions with respect to a single target object. The above imaging operation will be described below in detail. A user previously applies a label of a defective or non-defective product to a target object captured by the imaging apparatus 220 in the learning period. In the inspection period, generally, it is unknown whether the object is defective or non-defective with respect to the object captured by the imaging apparatus 220. In the present exemplary embodiment, the defective/non-defective determination apparatus 200 is connected to the imaging apparatus 220 to acquire a captured image of the target object from the imaging apparatus 220. However, an exemplary embodiment is not limited to the above. For example, a previously captured target object image can be stored in a storage medium so that the captured target object image can be read and acquired from the storage medium.

The image composition unit 202 receives the target object images captured under at least two mutually-different illumination conditions from the image acquisition unit 201, and creates a composite image by compositing these target object images. Herein, a captured image or a composite image acquired in the learning period is referred to as a learning target image, whereas a captured image or a composite image acquired in the inspection period is referred to as an inspection image. The image composition unit 202 will be described below in detail.

The comprehensive feature amount extraction unit 203 executes learning extraction processing. Specifically, the comprehensive feature amount extraction unit 203 comprehensively extracts feature amounts including a statistics amount of an image from at least each of two or more images from among the learning target images acquired by the image acquisition unit 201 and the learning target images created by the image composition unit 202. The comprehensive feature amount extraction unit 203 will be described below in detail. At this time, of the learning target images acquired by the image acquisition unit 201 and the learning target images created by the image composition unit 202, only the learning target images acquired by the image acquisition unit 201 can be specified as targets of feature amount extraction. Alternatively, of the learning target images acquired by the image acquisition unit 201 and the learning target images created by the image composition unit 202, only the learning target images created by the image composition unit 202 can be specified as targets of the feature amount extraction. Furthermore, both of the learning target images acquired by the image acquisition unit 201 and the learning target images created by the image composition unit 202 can be specified as targets of the feature amount extraction.

The feature amount combining unit 204 combines the feature amounts of respective images extracted by the comprehensive feature amount extraction unit 203 into one. The feature amount combining unit 204 will be described below in detail.

From the feature amounts combined by the feature amount combining unit 204, the feature amount selection unit 205 selects a feature amount useful for separating between non-defective products and defective products. The types of feature amounts selected by the feature amount selection unit 205 are stored in the selected feature amount saving unit 207.

The feature amount selection unit 205 will be described below in detail. The classifier generation unit 206 uses the feature amounts selected by the feature amount selection unit 205 to create a classifier for classifying non-defective products and defective products. The classifier generated by the classifier generation unit 206 is stored in the classifier saving unit 208. The classifier generation unit 206 will be described below in detail.

The selected feature amount extraction unit 209 executes inspection extraction processing. Specifically, the selected feature amount extraction unit 209 extracts a feature amount of a type stored in the selected feature amount saving unit 207, i.e., a feature amount selected by the feature amount selection unit 205, from the inspection images acquired by the image acquisition unit 201 or the inspection images created by the image composition unit 202. The selected feature amount extraction unit 209 will be described below in detail.

The determination unit 210 determines whether an appearance of the target object is defective or non-defective based on the feature amounts extracted by the selected feature amount extraction unit 209 and the classifier stored in the classifier saving unit 208.

The output unit 211 transmits a determination result indicating a defective or non-defective appearance of the target object to the external display apparatus 230 in a format displayable by the display apparatus 230 via an interface (not illustrated). In addition, the output unit 211 can transmit the inspection image used for determining whether the appearance of the target object is defective or non-defective to the display apparatus 230 together with the determination result indicating a defective or non-defective appearance of the target object.

The display apparatus 230 displays a determination result indicating a defective or non-defective appearance of the target object output by the output unit 211. For example, the determination result indicating a defective or non-defective appearance of the target object can be displayed in text such as “non-defective” or “defective”. However, a display mode of the determination result indicating a defective or non-defective appearance of the target object is not limited to the text display mode. For example, “non-defective” and “defective” may be distinguished and displayed in colors. Further, in addition to or in place of the above-described display mode, “defective” and “non-defective” can be output using sound. A liquid crystal display or a cathode-ray tube (CRT) display is examples of the display apparatus 230. The CPU 110 in FIG. 1 executes display control of the display apparatus 230.

### <Flowchart>

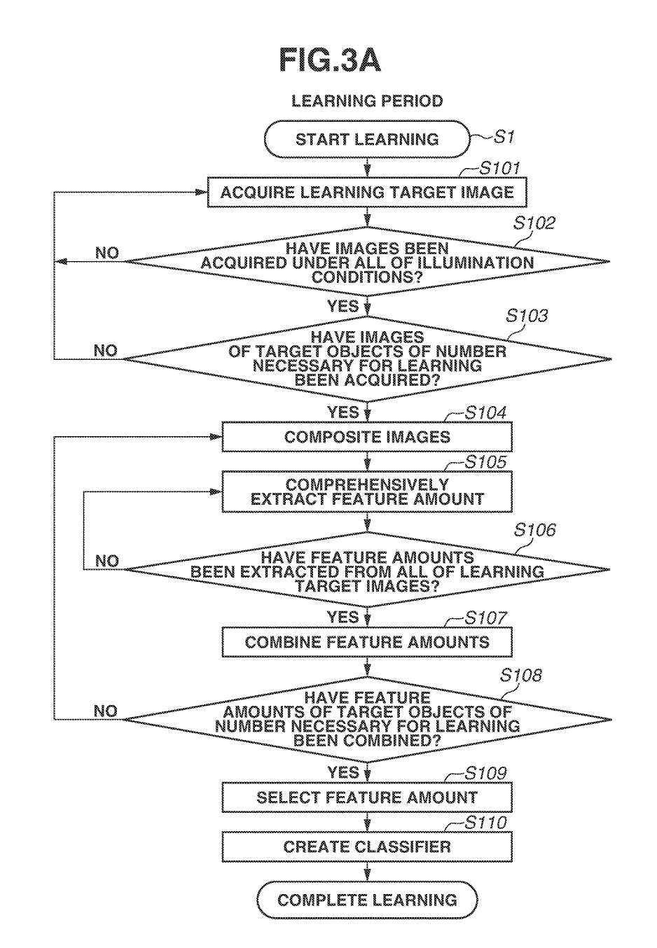

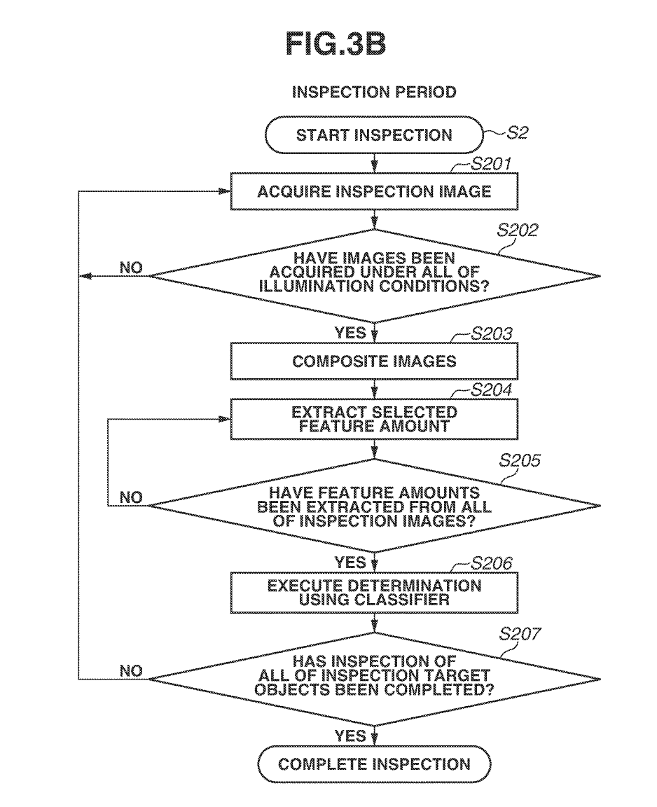

FIGS. 3A and 3B are flowcharts according to the present exemplary embodiment. Specifically, FIG. 3A is a flowchart illustrating an example of processing executed by the defective/non-defective determination apparatus 200 in a learning period. FIG. 3B is a flowchart illustrating an example of processing executed by the defective/non-defective determination apparatus 200 in an inspection period. Hereinafter, examples of the processing executed by the defective/non-defective determination apparatus 200 will be described with reference to the flowcharts in FIGS. 3A and 3B. As illustrated in FIGS. 3A and 3B, the processing executed by the defective/non-defective determination apparatus 200 according to the present exemplary embodiment basically consists of two steps, i.e., a learning step S1 and an inspection step S2. Hereinafter, each of the steps S1 and S2 will be described in detail.

### <Step S101>

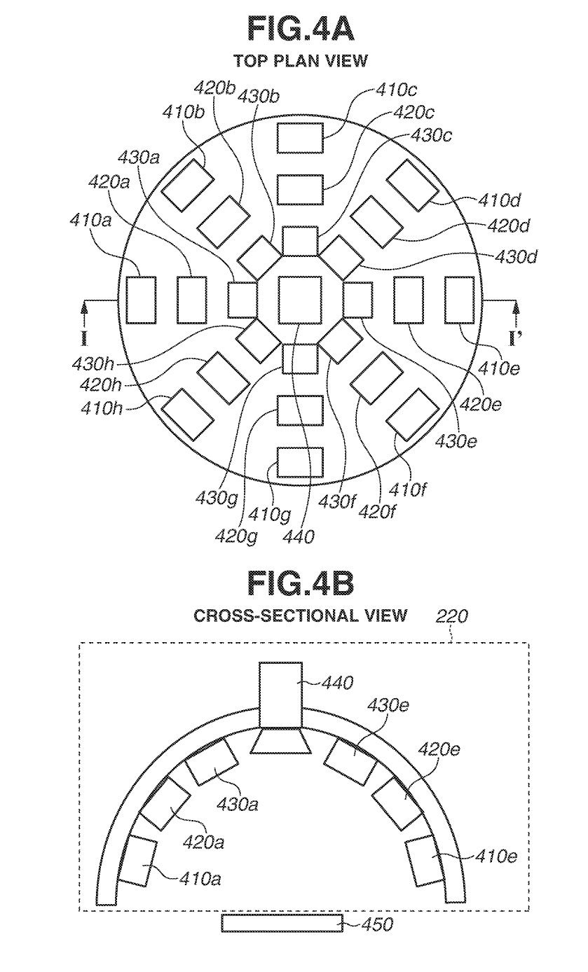

First, the learning step S1 illustrated in FIG. 3A will be described. In step S101, the image acquisition unit 201 acquires learning target images captured under a plurality of illumination conditions from the imaging apparatus 220. FIG. 4A is a diagram illustrating an example of a top plan view of the imaging apparatus 220 whereas FIG. 4B is a diagram illustrating an example of a cross-sectional view of the imaging apparatus 220 (surrounded by a dotted line in FIG. 4B) and a target object 450. FIG. 4B is a cross-sectional view taken along a line I-I′ in FIG. 4A.

As illustrated in FIG. 4B, the imaging apparatus 220 includes a camera 440. An optical axis of the camera 440 is set to be vertical with respect to a plate face of the target object 450. Further, the imaging apparatus 220 includes illuminations 410a to 410h, 420a to 420h, and 430a to 430h having different positions in a latitudinal direction (height positions), which are arranged in eight azimuths in a longitudinal direction (circumferential direction). As described above, in the present exemplary embodiment, it is assumed that the imaging apparatus 220 captures images under at least two or more imaging conditions with respect to the single target object 450. For example, at least any one of the employable illuminations 410a to 410h, 420a to 420h, or 430a to 430h (i.e., irradiation direction), a light amount of the illuminations 410a to 410h, 420a to 420h, or 430a to 430h, and exposure time of the image sensor of the camera 440 may be changed. With this configuration, images are captured under a plurality of illumination conditions. An example of the illumination condition will be described below. Further, an industrial camera is used as the camera 440, and either a monochrome image or a color image may be captured thereby. In step S101, in order to acquire a learning target image, an image of an external portion of a product (target object 450) previously known as a non-defective product or a defective product is captured, and that image is acquired. The user previously informs the defective/non-defective determination apparatus 200 about whether the target object 450 is a non-defective product or a defective product. In addition, the target object 450 is formed of a same material.

### <Step S102>

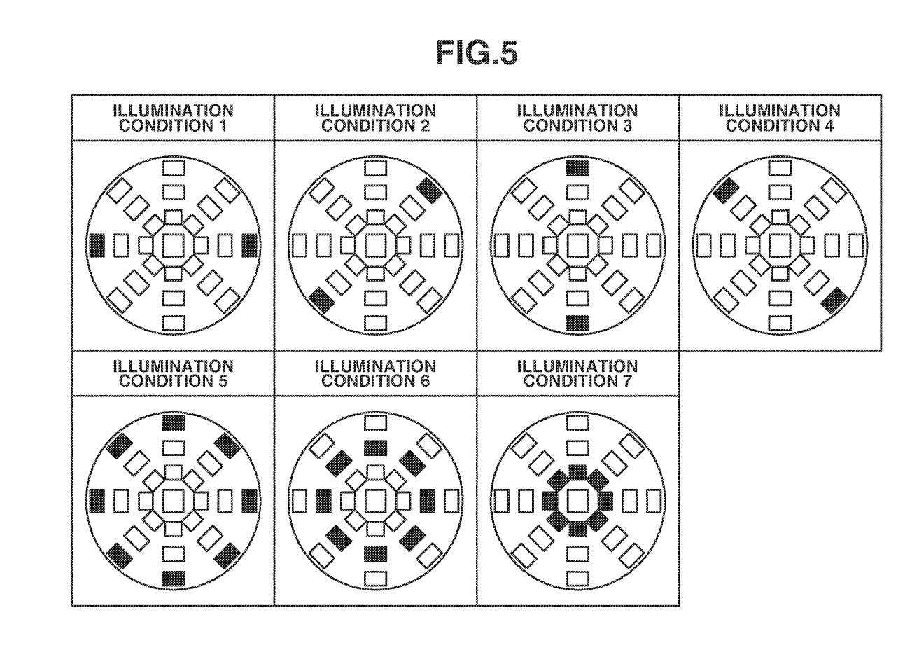

In step S102, the image acquisition unit 201 determines whether images have been acquired under all of the illumination conditions previously set to the defective/non-defective determination apparatus 200. As a result of the determination, if the images have not been acquired under all of the illumination conditions (NO in step S102), the processing returns to step S101, and images are captured again. FIG. 5 is a diagram illustrating examples of the illumination conditions according to the present exemplary embodiment. As illustrated in FIG. 5, in the present exemplary embodiment, description will be given as an example according to an exemplary embodiment in which the illumination condition is changed by changing the employable illuminations from among the illuminations 410a to 410h, 420a to 420h, and 430a to 430h. In FIG. 5, the top plan view of the imaging apparatus 220 of FIG. 4A is illustrated in a simplified manner, and the employable illuminations are expressed by filled rectangular shapes. In the present exemplary embodiment, illumination conditions of seven types are provided.

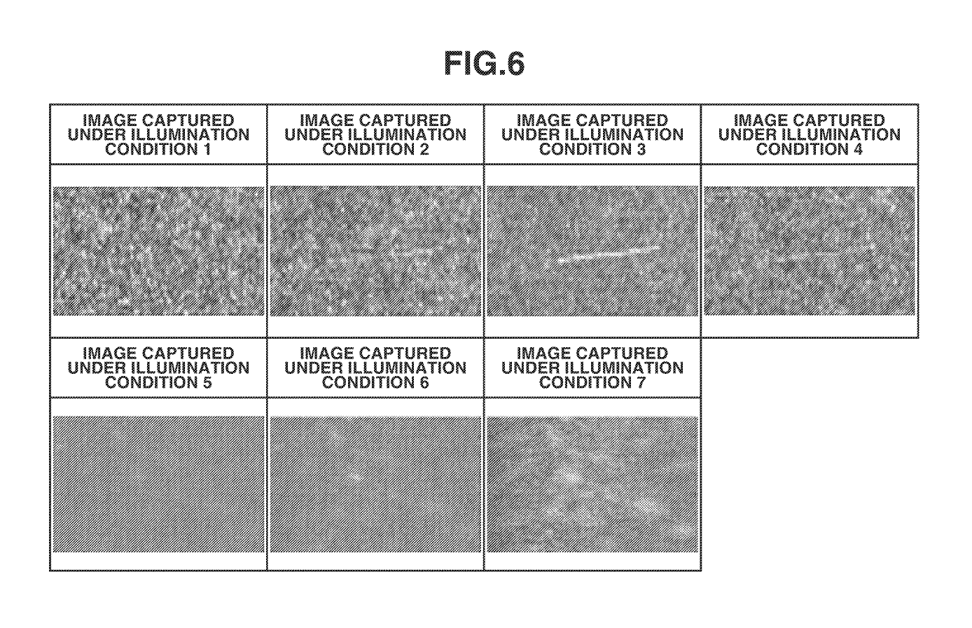

The images are captured under a plurality of illumination conditions because defects such as scratches, dents, or coating unevenness are emphasized depending on the illumination conditions. For example, a scratch defect is emphasized on the images captured under the illumination conditions 1 to 4, whereas an unevenness defect is emphasized on the images captured under the illumination conditions 5 to 7. FIG. 6 is a diagram illustrating examples of images of defect portions captured under the respective illumination conditions according to the present exemplary embodiment. In the images captured under the illumination conditions 1 to 4, a scratch defect extending in a direction vertical to a direction that connects the two lighted illuminations is likely to be emphasized. This is because a reflectance is significantly changed at a portion having a scratch defect because the illumination light is emitted from a position at a low latitude, in a direction vertical to the scratch defect. In FIG. 6, the scratch defect is visualized the most in the image captured under the illumination condition 3. On the other hand, the unevenness defect is more likely emphasized on the images captured under the illumination conditions 5 to 7. Because illumination is uniformly applied in a longitudinal direction under the illumination conditions 5 to 7, the illumination unevenness is less likely to occur while the unevenness defect is emphasized. In FIG. 6, the unevenness defect is visualized the most in the image captured under the illumination condition 7. Under what illumination condition from among the illumination conditions 5 to 7 the unevenness defect is emphasized the most depends on the cause and the type of the unevenness defect. The processing proceeds to step S103 when images are captured under all of the seven illumination conditions. In the present exemplary embodiment, the illumination condition is changed by changing the employable illuminations 410a to 410h, 420a to 420h, and 430a to 430h. However, the illumination condition is not limited to the employable illuminations 410a to 410h, 420a to 420h, and 430a to 430h. As described above, for example, the illumination condition may be changed by changing the light amount of the illuminations 410a to 410h, 420a to 420h, and 430a to 430h or exposure time of the camera 440.

### <Step S103>

In step S103, the image acquisition unit 201 determines whether the target object images of the number necessary for learning have been acquired. As a result of the determination, if the target object images of the number necessary for learning have not been acquired (NO in step S103), the processing returns to step S101, and images are captured again. In the present exemplary embodiment, approximately 150 pieces of non-defective product images and 50 pieces of defective product images are acquired as the learning target images under one illumination condition. Accordingly, when the processing in step S103 is completed, non-defective product images of 150×7 pieces and defective product images of 50×7 pieces will be acquired as the learning target images. When the images of the above number of pieces are acquired, the processing proceeds to step S104. The following processing in steps S104 to S107 is executed with respect to each of two hundred target objects.

### <Step S104>

In step S104, of the seven images captured under the illumination conditions 1 to 7 with respect to the same target object, the image composition unit 202 composites the images captured under the illumination conditions 1 to 4. As described above, in the present exemplary embodiment, the image composition unit 202 composites the images captured under the illumination conditions 1 to 4 to output a composite image as a learning target image, and directly outputs the images captured under the illumination conditions 5 to 7 as learning target images without composition. As described above, because the illumination conditions 1 to 4 have dependences on azimuth angles in terms of illumination usage directions, a direction of the scratch defect to be emphasized may vary in each of the illumination conditions 1 to 4. Accordingly, when a composite image is generated by taking a sum of the pixel values of mutually-corresponding positions in the images captured under the illumination conditions 1 to 4, it is possible to generate a composite image in which a scratch defect is emphasized in various angles. Herein, for the sake of simplicity, a method for creating a composite image by taking a sum of the images captured under the illumination conditions 1 to 4 has been described as an example. However, the method is not limited to the above. For example, a composite image in which the defect is further emphasized may be generated through image processing employing four arithmetic operations. For example, a composite image can be generated through operation using statistics amounts of the images captured under the illumination conditions 1 to 4 and a statistics amount between a plurality of images from among the images captured under the illumination conditions 1 to 4 in addition to or in place of the operation using the pixel values of the images captured under the illumination conditions 1 to 4.

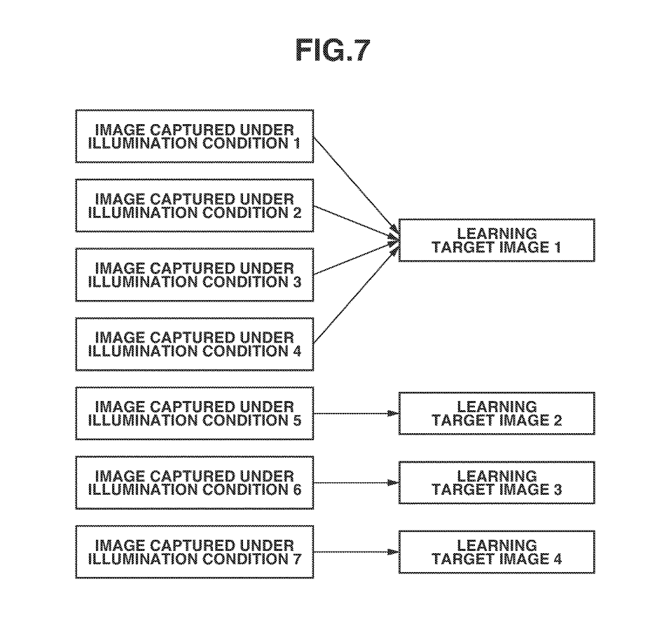

FIG. 7 is a diagram illustrating a configuration example of a learning target image. In FIG. 7, a learning target image 1 is a composite image of the images captured under the illumination conditions 1 to 4, whereas learning target images 2 to 4 are the very images captured under the illumination conditions 5 to 7. As described above, in the present exemplary embodiment, a total of four kinds of learning target images 1 to 4 are created with respect to the same target object.

### <Step S105>

In step S105, the comprehensive feature amount extraction unit 203 comprehensively extracts the feature amounts from a learning target image of one target object. The comprehensive feature amount extraction unit 203 creates pyramid hierarchy images having different frequencies from a learning target image of the one target object, and extracts the feature amounts by executing statistical operation and filtering processing on each of the pyramid hierarchy images.

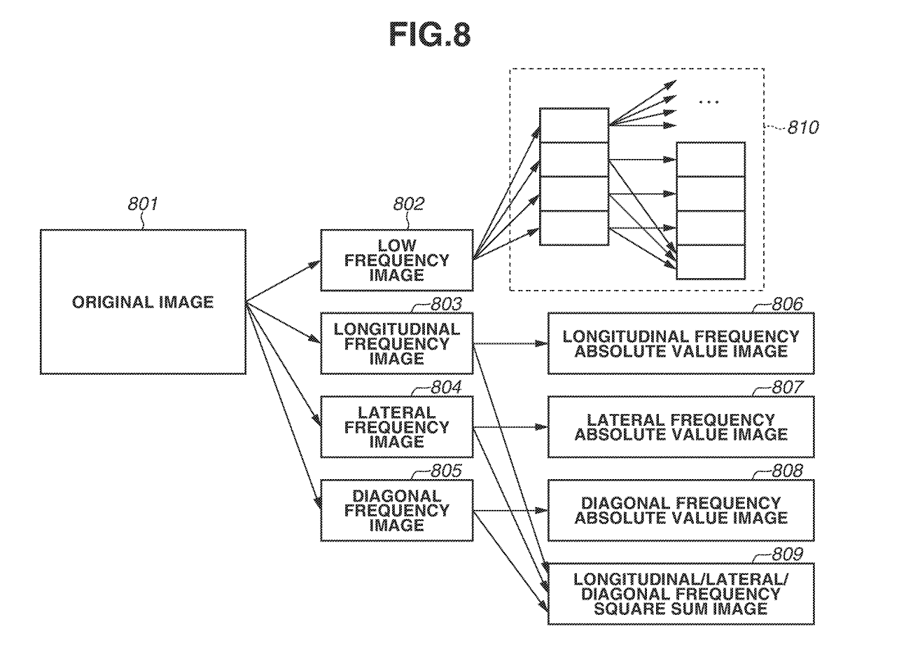

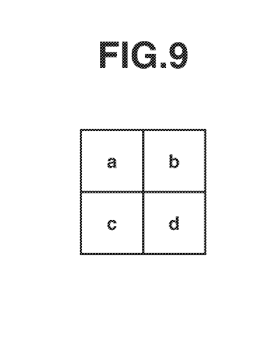

First, an example of a creation method of the pyramid hierarchy images will be described in detail. In the present exemplary embodiment, the pyramid hierarchy images are created through wavelet transformation (i.e., frequency transformation). FIG. 8 is a diagram illustrating an example of the creation method of the pyramid hierarchy images according to the present exemplary embodiment. First, the comprehensive feature amount extraction unit 203 uses a learning target image acquired in step S104 as an original image 801 to create four kinds of images i.e., a low frequency image 802, a longitudinal frequency image 803, a lateral frequency image 804, and a diagonal frequency image 805 from the original image 801. All of the four images 802, 803, 804, and 805 are reduced to one-fourth of the size of the original image 801. FIG. 9 is a diagram illustrating pixel numbers for describing the wavelet transformation. As illustrated in FIG. 9, an upper-left pixel, an upper-right pixel, a lower-left pixel, and a lower-right pixel are referred to as “a”, “b”, “c”, and “d” respectively. In this case, the low frequency image 802, the longitudinal frequency image 803, the lateral frequency image 804, and the diagonal frequency image 805 are created by respectively executing the pixel value conversion expressed by the following formulas 1, 2, 3, and 4 with respect to the original image 801.

(a+b+c+d)/4 (1)

(a+b−c−d)/4 (2)

(a−b+c−d)/4 (3)

(a−b−c+d)/4 (4)

Further, from the three images thus created as the longitudinal frequency image 803, the lateral frequency image 804, and the diagonal frequency image 805, the comprehensive feature amount extraction unit 203 creates the following four kinds of images. In other words, the comprehensive feature amount extraction unit 203 creates four images i.e., a longitudinal frequency absolute value image 806, a lateral frequency absolute value image 807, a diagonal frequency absolute value image 808, and a longitudinal/lateral/diagonal frequency square sum image 809. The longitudinal frequency absolute value image 806, the lateral frequency absolute value image 807, and the diagonal frequency absolute value image 808 are created by respectively taking the absolute values of the longitudinal frequency image 803, the lateral frequency image 804, and the diagonal frequency image 805. Further, the longitudinal/lateral/diagonal frequency square sum image 809 is created by calculating a square sum of the longitudinal frequency image 803, the lateral frequency image 804, and the diagonal frequency image 805. In other words, the comprehensive feature amount extraction unit 203 acquires square values of respective positions (pixels) of the longitudinal frequency image 803, the lateral frequency image 804, and the diagonal frequency image 805. Then, the comprehensive feature amount extraction unit 203 creates the longitudinal/lateral/diagonal frequency square sum image 809 by adding the square values at the mutually-corresponding positions of the longitudinal frequency image 803, the lateral frequency image 804, and the diagonal frequency image 805.

In FIG. 8, eight images i.e., the low frequency image 802 to the longitudinal/lateral/diagonal frequency square sum image 809 acquired from the original image 801 are referred to as an image group of a first hierarchy.

Subsequently, the comprehensive feature amount extraction unit 203 executes image conversion the same as the image conversion for creating the image group of the first hierarchy on the low frequency image 802 to create the above eight images as an image group of a second hierarchy. Further, the comprehensive feature amount extraction unit 203 executes the same processing on a low frequency image in the second hierarchy to create the above eight images as an image group of a third hierarchy. The processing for creating the eight images (i.e., an image group of each hierarchy) is repeatedly executed with respect to the low frequency images of respective hierarchies until a size of the low frequency image has a value equal to or less than a certain value. This repetitive processing is illustrated inside of a dashed line portion 810 in FIG. 8. By repeating the above processing, eight images are respectively created in each of the hierarchies. For example, in a case where the above processing is repeated up to tenth hierarchies, eighty-one images (1 original image+10 hierarchies×8 images) are created with respect to a single image. A creation method of the pyramid hierarchy images has been described as the above. In the present exemplary embodiment, a creation method of the pyramid hierarchy images (images having frequencies different from that of the original image 801) using the wavelet transformation has been described as an example. However, the creation method of the pyramid hierarchy images (images having frequencies different from that of the original image 801) is not limited to the method using the wavelet transformation. For example, the pyramid hierarchy images (images having frequencies different from that of the original image 801) may be created by executing the Fourier transformation on the original image 801.

Next, a method for extracting a feature amount by executing statistical operation and filtering operation on each of the pyramid hierarchy images will be described in detail.

First, statistical operation will be described. The comprehensive feature amount extraction unit 203 calculates an average, a dispersion, a kurtosis, a skewness, a maximum value, and a minimum value of each of the pyramid hierarchy images, and assigns these values as feature amounts. A statistics amount other than the above may be assigned as the feature amount.

Subsequently, a feature amount extracted through filtering processing will be described. Herein, results calculated through two kinds of filtering processing for emphasizing a scratch defect and an unevenness defect are assigned as the feature amounts. The processing thereof will be described below in sequence.

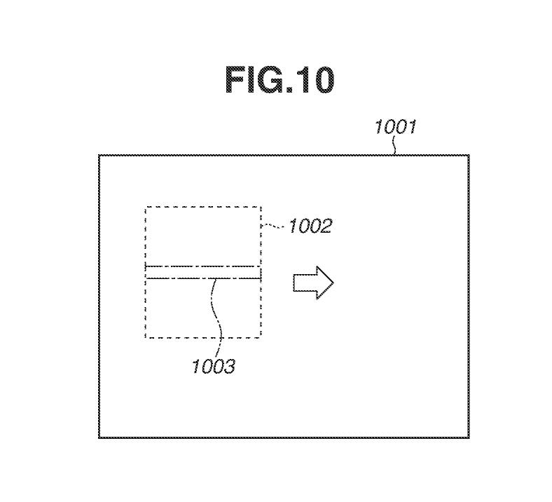

First, a feature amount that emphasizes a scratch defect will be described. In many cases, the scratch defect occurs when a target object is scratched by a certain projection at the time of production, and the scratch defect tends to have a linear shape that is long in one direction. FIG. 10 is a schematic diagram illustrating an example of a calculation method of a feature amount that emphasizes the scratch defect according to the present exemplary embodiment. In FIG. 10, a solid rectangular frame 1001 represents one of the pyramid hierarchy images. With respect to the rectangular frame (pyramid hierarchy image) 1001, the comprehensive feature amount extraction unit 203 executes convolution operation by using a rectangular region 1002 (a dotted rectangular frame in FIG. 10) and a rectangular region 1003 (a dashed-dotted rectangular frame in FIG. 10) having a long linear shape extending in one direction. Through the convolution operation, the feature amount that emphasizes the scratch defect is extracted.

In the present exemplary embodiment, the comprehensive feature amount extraction unit 203 scans the entire rectangular frame (pyramid hierarchy image) 1001 (see an arrow in FIG. 10). Then, the comprehensive feature amount extraction unit 203 calculates a ratio of an average value of the pixels within the rectangular region 1002 excluding the linear-shaped rectangular region 1003 to an average value of the pixels in the linear-shaped rectangular region 1003. Then, a maximum value and a minimum value thereof are assigned as the feature amounts. Because the rectangular region 1003 has a linear shape, a feature amount that further emphasizes the scratch defect can be extracted. Further, in FIG. 10, the rectangular frame (pyramid hierarchy image) 1001 and the linear-shaped rectangular region 1003 are parallel to each other. However, the linear-shape defect may occur in various directions at 360 degrees. Therefore, for example, the comprehensive feature amount extraction unit 203 rotates the rectangular frame (pyramid hierarchy image) 1001 in 24 directions at every 15 degrees to calculate respective feature amounts. Further, the feature amounts are provided in a plurality of filter sizes.

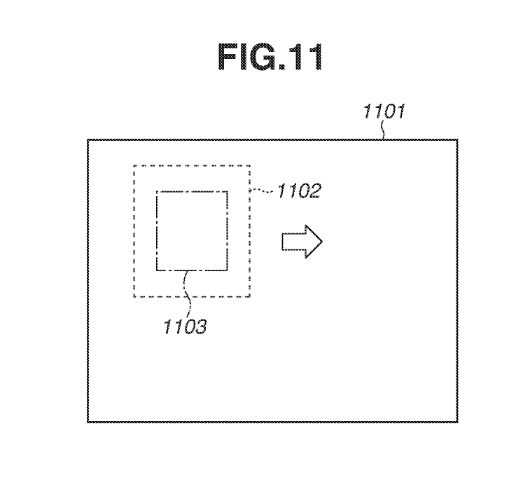

Secondly, a feature amount that emphasizes the unevenness defect will be described. The unevenness defect is generated due to uneven coating or uneven resin molding, and is likely to occur extensively. FIG. 11 is a schematic diagram illustrating an example of a calculation method of the feature amount that emphasizes the unevenness defect according to the present exemplary embodiment. A rectangular region 1101 (a solid rectangular frame in FIG. 11) represents one of the pyramid hierarchy images. With respect to the rectangular region (pyramid hierarchy image) 1101, the comprehensive feature amount extraction unit 203 executes convolution operation by using a rectangular region 1102 (a dashed rectangular frame in FIG. 11) and a rectangular region 1103 (a dashed-dotted rectangular frame in FIG. 11). Through the convolution operation, the feature amount that emphasizes the unevenness defect is extracted. Herein, the rectangular region 1103 (a dashed-dotted rectangular frame in FIG. 11) is a region including the unevenness defect within the rectangular region 1102.

In the present exemplary embodiment, the comprehensive feature amount extraction unit 203 scans the entire rectangular region 1101 (see an arrow in FIG. 11) to calculate a ratio of an average value of pixels in the rectangular region 1102 excluding the rectangular region 1103 to an average value of pixels in the rectangular region 1103. Then, the comprehensive feature amount extraction unit 203 assigns a maximum value and a minimum value thereof as the feature amounts. Because the rectangular region 1103 is a region including the unevenness defect, the feature amounts that further emphasize the unevenness defect can be calculated. Further, similar to the case of the feature amounts of the scratch defect, the feature amounts are provided in a plurality of filter sizes.

Herein, the calculation method has been described by taking the calculation of a ratio of the average values as an example. However, the feature amount is not limited to the ratio of the average values. For example, a ratio of dispersion or standard deviation may be used as the feature amount, and a difference may be used as the feature amount instead of using the ratio. Further, in the present exemplary embodiment, the maximum value and the minimum value have been calculated after executing the scanning. However, the maximum value and the minimum value do not always have to be calculated. Another statistics amount such as an average or a dispersion may be calculated from the scanning result.

Further, in the present exemplary embodiment, the feature amount has been extracted by creating the pyramid hierarchy images. However, the pyramid hierarchy images do not always have to be created. For example, the feature amount may be extracted from only the original image. Further, types of the feature amounts are not limited to those described in the present exemplary embodiment. For example, the feature amount can be calculated by executing at least any one of statistical operation, convolution operation, binarization processing, and differentiation operation with respect to the pyramid hierarchy images or the original image 801.

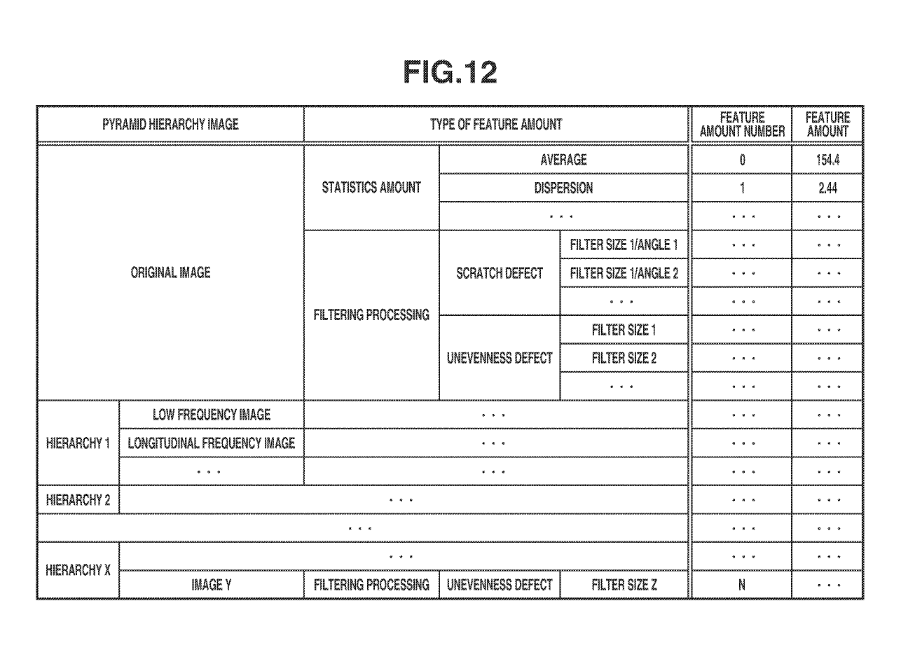

The comprehensive feature amount extraction unit 203 applies numbers to the feature amounts derived as the above, and temporarily stores the feature amounts in a memory together with the numbers. FIG. 12 is a table illustrating a list of feature amounts according to the present exemplary embodiment. As there are a large number of types of feature amounts, in FIG. 12, most of the portions in the table are illustrated in a simplified manner. Further, for the sake of processing described below, with respect to one learning target image, it is assumed that a total of “N” feature amounts are to be extracted, while the operation is executed until a feature amount for the unevenness defect having a filter size “Z” included in a pyramid hierarchy image “Y” of an X-th hierarchy, is extracted. As described above, the comprehensive feature amount extraction unit 203 comprehensively extracts approximately 4000 feature amounts (N=4000) from the learning target image.

### <Step S106>

In step S106, the comprehensive feature amount extraction unit 203 determines whether extraction of feature amounts executed in step S105 has been completed with respect to the four learning target images 1 to 4 created in step S104. As a result of the determination, if the feature amounts have not been extracted from the four learning target images 1 to 4 (NO in step S106), the processing returns to step S105, so that the feature amounts are extracted again. Then, if the comprehensive feature amounts have been extracted from all of the four learning target images 1 to 4 (YES in step S106), the processing proceeds to step S107.

### <Step S107>

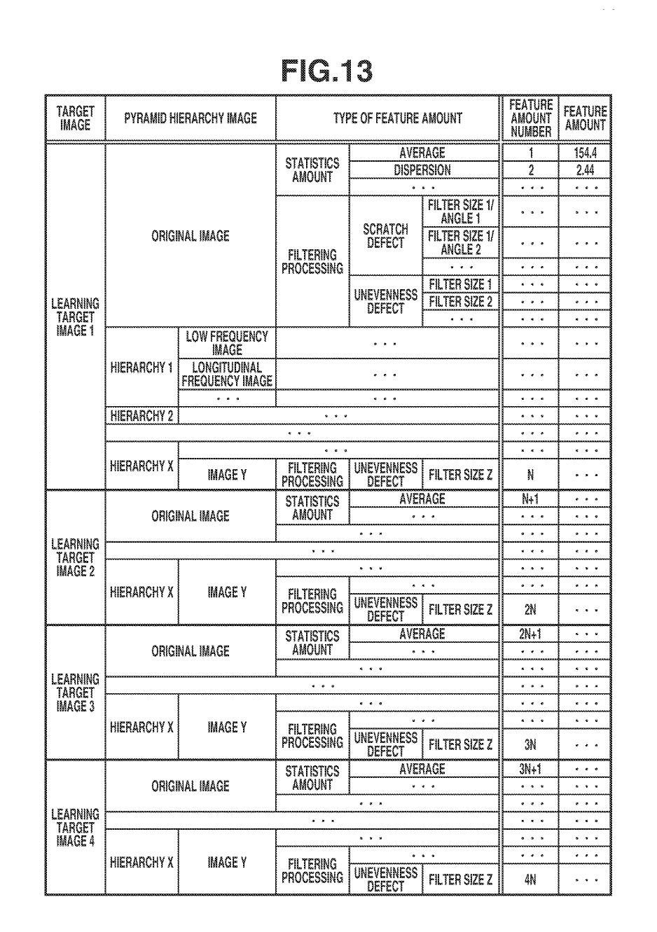

In step S107, the feature amount combining unit 204 combines the comprehensive feature amounts of all of the four learning target images 1 to 4 extracted through the processing in steps S105 and S106. FIG. 13 is a table illustrating a list of combined feature amounts. Herein, the feature amount numbers are assigned from 1 to 4N. In the present exemplary embodiment, all of the feature amounts 1 to 4N are combined through feature amount combining processing executed in step S107. However, all of the feature amounts 1 to 4N do not always have to be combined. For example, in a case where one feature amount that is obviously not necessary is already known at the beginning, this feature amount does not have to be combined.

### <Step S108>

In step S108, the feature amount combining unit 204 determines whether feature amounts of the target objects of the number necessary for learning have been combined. As a result of the determination, if the feature amounts of the target objects of the number necessary for learning have not been combined (NO in step S108), the processing returns to step S104, and the processing in steps S104 to S108 is executed repeatedly until the feature amounts of the target objects of the number necessary for learning have been combined. As described in step S103, feature amounts of 150 pieces of target objects are combined with respect to the non-defective products, whereas feature amounts of 50 pieces of target objects are combined with respect to the defective products. When the feature amounts of the target objects of the number necessary for learning are combined (YES in step S108), the processing proceeds to step S109.

### <Step S109>

In step S109, from among the feature amounts combined through the processing up to step S108, the feature amount selection unit 205 selects and determines a feature amount useful for separating between non-defective products and defective products, i.e., a type of feature amount used for the inspection. Specifically, the feature amount selection unit 205 creates a ranking of types of the feature amounts useful for separating between non-defective products and defective products, and selects the feature amounts by determining how many feature amounts from the top of the ranking are to be used (i.e., the number of feature amounts to be used).

First, an example of a ranking creation method will be described. A number “j” (j=1, 2, . . . , 200) is applied to each of the learning target objects. The numbers 1 to 150 are applied to non-defective products whereas numbers 151 to 200 are applied to defective products, and the i-th (i=1, 2, . . . , 4N) feature amount after combining the feature amounts is expressed as “x_{i, j}”. With respect to each of the types of the feature amounts, the feature amount selection unit 205 calculates an average “xₐᵥₑ_{_}ᵢ” and a standard deviation “σₐᵥₑ_{_}ᵢ” of the 150 pieces of non-defective products, and creates a probability density function f(x_{i, j}) in which the feature amount “x_{i, j}” is generated by assuming the probability density function f(x_{i, j}) as a normal distribution. At this time, the probability density function f(x_{i, j}) can be expressed by the following formula 5.

$$f ( {x}_{i , j} ) = \frac{1}{\sqrt{2 {πσ}_{ave\_i}^{2}}} exp ( - \frac{{( {x}_{i , j} - {x}_{ave\_i} )}^{2}}{2 {σ}_{ave\_i}^{2}} ) \qquad ( 5 )$$

Subsequently, the feature amount selection unit 205 calculates a product of the probability density function f(x_{i, j}) of all of defective products used in the learning, and takes the acquired value as an evaluation value g(i) for creating the ranking. Herein, the evaluation value g(i) can be expressed by the following formula 6.

$$g ( i ) = {\prod }_{j = 151}^{200} f ( {x}_{i , j} ) \qquad ( 6 )$$

The feature amount is more useful for separating between non-defective products and defective products when the evaluation value g(i) thereof is smaller. Therefore, the feature amount selection unit 205 sorts and ranks the evaluation values g(i) in an order from the smallest value to create a ranking of types of feature amounts. When the ranking is created, a combination of the feature amounts may be evaluated instead of evaluating the feature amount itself. In a case where the combination of feature amounts is evaluated, evaluation is executed by creating the probability density functions of a number equivalent to the number of dimensions of the feature amounts to be combined. For example, with respect to a combination of the i-th and the k-th two-dimensional feature amounts, the formulas 5 and 6 are expressed in a two-dimensional manner, so that a probability density function f(x_{i, j}, x_{k, j}) and an evaluation value g(i, k) are respectively expressed by the following formulas 7 and 8.

$$\begin{matrix} f ( {x}_{i , j} , {x}_{k , j} ) = \frac{1}{\sqrt{2 {πσ}_{ave\_i}^{2}}} exp ( - \frac{{( {x}_{i , j} - {x}_{ave\_i} )}^{2}}{2 {σ}_{ave\_i}^{2}} ) \times \frac{1}{\sqrt{2 {πσ}_{ave\_k}^{2}}} exp ( - \frac{{( {x}_{k . j} - {x}_{ave\_k} )}^{2}}{2 {σ}_{ave\_k}^{2}} ) & ( 7 ) \\ g ( i , k ) = {\prod }_{j = 151}^{200} f ( {x}_{i , j} , {x}_{k , j} ) & ( 8 )\end{matrix}$$

One feature amount “k” (k-th feature amount) is fixed, and the feature amounts are sorted and scored in an order from a smallest evaluation value g(i, k). For example, with respect to the one feature amount “k”, the feature amounts ranked in the top 10 are scored in such a manner that an i-th feature amount having a smallest evaluation value g(i, k) is scored 10 points whereas an i′-th feature amount having a second-smallest evaluation value g(i′, k) is scored 9 points, and so on. By executing this scoring with respect to all of the feature amounts k, the ranking of types of combined feature amounts is created in consideration of a combination of the feature amounts.

Next, the feature amount selection unit 205 determines how many types of feature amounts from the highest-ranked type (i.e., the number of feature amounts to be used) is used. First, with respect to all of the learning target objects, the feature amount selection unit 205 calculates scores by taking a number of feature amounts to be used as a parameter. Specifically, the number of feature amounts to be used is taken as “p” while the type of feature amount sorted in the order of the ranking is taken as “m”, and a score h(p, j) of a j-th target object is expressed by the following formula 9.

$$h ( p , j ) = \sqrt{{\sum }_{m = 1}^{p} {( \frac{{x}_{m , j} - {x}_{ave\_m}}{{σ}_{ave\_m}} )}^{2}} \qquad ( 9 )$$

Based on the score h(p, j), the feature amount selection unit 205 arranges all of the learning target objects in the order of the scores for each of feature amounts to be used. It is assumed to be known that a learning target object is a non-defective product or a defective product. When the target objects are arranged in the order of the scores, non-defective products and defective products are also arranged in that order of the scores. The above-described data can be acquired as many as candidates of the number “p” of feature amounts to be used. The feature amount selection unit 205 specifies a separation degree (a value indicating how precisely non-defective products and defective products can be separated) of data corresponding to the number of candidates of the number “p” of feature amounts to be used, as an evaluation value, and determines the number “p” of feature amounts to be used, from the data that acquire the highest evaluation value. An area under curve (AUC) of a receiver operating characteristic (ROC) curve can be used as the separation degree of data. Further, a passage rate of non-defective products (ratio of the number of non-defective products to a total number of target objects) when overlooking of defective products regarded as learning target data is zero, may be used as the separation degree of data. By employing the above method, the feature amount selection unit 205 selects approximately 50 to 100 types of feature amounts to be used from among 4N types of combined feature amounts (i.e., 16000 types of feature amounts when N=4000). In the present exemplary embodiment, although the number of feature amounts to be used has been determined, a fixed value may be applied to the number of feature amounts to be used. The selected types of feature amounts are stored in the selected feature amount saving unit 207.

### <Step S110>

In step S110, the classifier generation unit 206 creates a classifier. Specifically, with respect to the score calculated through the formula 9, the classifier generation unit 206 determines a threshold value for determining whether the target object is a non-defective product or a defective product at the time of inspection. Herein, depending on whether overlooking of defective products is partially allowed or not allowed, the user determines the threshold value of the score for separating between non-defective products and defective products according to the condition of a production line. Then, the classifier saving unit 208 stores the generated classifier. Processing executed in the learning step S1 has been described as the above.

### <Step S201>

Next, the inspection step S2 illustrated in FIG. 3B will be described. In step S201, the image acquisition unit 201 acquires inspection images captured under a plurality of imaging conditions from the imaging apparatus 220. Unlike the learning period, in the inspection period, whether the target object is a non-defective product or a defective product is unknown.

### <Step S202>

In step S202, the image acquisition unit 201 determines whether images have been acquired under all of the illumination conditions previously set to the defective/non-defective determination apparatus 200. As a result of the determination, if the images have not been acquired under all of the illumination conditions (NO in step S202), the processing returns to step S201, and images are captured repeatedly. In the present exemplary embodiment, the processing proceeds to step S203 when the images have been acquired under seven illumination conditions.

### <Step S203>

In step S203, the image composition unit 202 creates a composite image by using seven images of the target object. As with the case of learning target images, in the present exemplary embodiment, the image composition unit 202 composites the images captured under the illumination conditions 1 to 4 to output a composite image, and directly outputs the images captured under the illumination conditions 5 to 7 without composition. Accordingly, a total of four inspection images are created.

### <Step S204>

In step S204, the selected feature amount extraction unit 209 receives a type of the feature amount selected by the feature amount selection unit 205 from the selected feature amount saving unit 207, and calculates a value of the feature amount from the inspection image based on the type of the feature amount. A calculation method of the value of each feature amount is similar to the method described in step S105.

### <Step S205>

In step S205, the selected feature amount extraction unit 209 determines whether extraction of feature amounts in step S204 has been completed with respect to the four inspection images created in step S203. As a result of the determination, if the feature amounts have not been extracted from the four inspection images (NO in step S205), the processing returns to step S204, so that the feature amounts are extracted repeatedly. Then, if the feature amounts have been extracted from all of the four inspection images (YES in step S205), the processing proceeds to step S206.

In the present exemplary embodiment, with respect to the processing in steps S202 to S205, as with the case of the processing in the learning period, images are captured under all of the seven illumination conditions, and four inspection images are created by compositing the images captured under the illumination conditions 1 to 4. However, the exemplary embodiment is not limited thereto. For example, depending on the feature amount selected by the feature amount selection unit 205, illumination conditions or inspection images may be omitted if there are any unnecessary illumination conditions or inspection images.

### <Step S206>

In step S206, the determination unit 210 calculates a score of the inspection target object by inserting a value of the feature amount calculated through the processing up to step S205 into the formula 9. Then, the determination unit 210 compares the score of the inspection target object and the threshold value stored in the classifier saving unit 208, and determines whether the inspection target object is a non-defective product or a defective product based on the comparison result. At this time, the determination unit 210 outputs information indicating the determination result to the display apparatus 230 via the output unit 211.

### <Step S207>

In step S207, the determination unit 210 determines whether inspection of all of the inspection target objects has been completed. As a result of the determination, if inspection of all of the inspection target objects has not been completed (NO in step S207), the processing returns to step S201, so that images of other inspection target objects are captured repeatedly.

Respective processing steps has been described in detail as the above.

### <Description of Effect of Present Exemplary Embodiment>

Next, effect of the present exemplary embodiment will be described in detail. For illustrative purpose, the present exemplary embodiment will be compared with a case where the learning/inspection processing is executed without acquiring the combined feature amount in step S107.

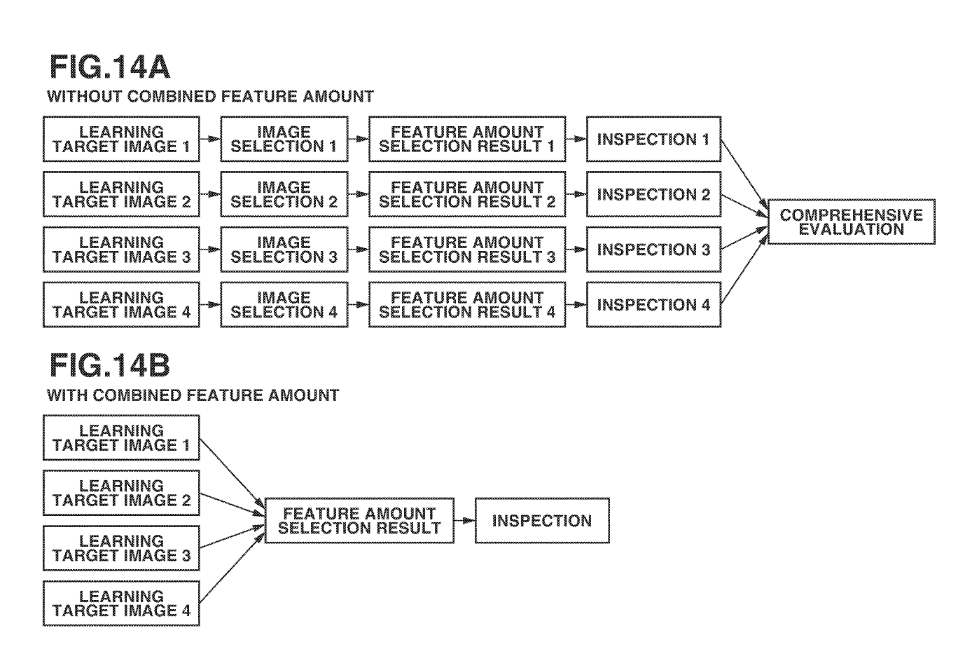

FIG. 14A is a diagram illustrating an example of operation flow excluding the feature amount combining operation in step S107, whereas FIG. 14B is a diagram illustrating an example of operation flow including the feature amount combining operation in step S107 according to the present exemplary embodiment. As illustrated in FIG. 14A, when the feature amounts are not combined, it is necessary to select an image of a defective product (“IMAGE SELECTION 1 to 4” in FIG. 14A) with respect to each of the four learning target images 1 to 4. For example, as illustrated in FIG. 7, the learning target image 1 is a composite image created from the images captured under the illumination conditions 1 to 4, and thus an unevenness defect tends to be less visualized in the learning target image 1 because a scratch defect is likely to be visualized under the illumination conditions 1 to 4. Because the image in which a defect is not visualized cannot be treated as an image of the defective product even if the target object is labeled as a defective product, such an image has to be eliminated from the defective product images.

Further, in many cases, it may be difficult to select the above-described defective product image. For example, with respect to the same defect in a target object, there is a case where the defect is clearly visualized in the learning target image 1, whereas in the learning target image 2, that defect is merely visualized to an extent similar to an extent of variations in pixel values of a non-defective product image. At this time, the learning target image 1 can be used as a learning target image of a defective product. However, if the learning target image 2 is used as a learning target image of a defective product, a redundant feature amount is likely to be selected when the feature amount useful for separating between non-defective products and defective products is selected. As a result, this may lead to degradation of performance of the classifier.

Further, the feature amount is selected from each of the four learning target images 1 to 4 in step S109, and thus four results are created with respect to the selection of feature amounts. Accordingly, the inspection has to be executed four times repeatedly. Generally, the four inspection results are evaluated comprehensively, and the target object determined to be the non-defective product in all of the inspections is comprehensively evaluated as the non-defective product.

On the other hand, the above problem can be solved if the feature amounts are to be combined. Because the feature amount is selected after combining the feature amounts, the defect can be visualized as long as the defect is visualized in any of the learning target images 1 to 4. Therefore, unlike the case where the feature amounts are not combined, it is not necessary to select an image of the defective-product. Further, the feature amount that emphasizes the scratch defect is selected from the learning target image 1, whereas the feature amount that emphasizes the unevenness defect is likely to be selected from the learning target images 2 to 4. Accordingly, even in a case where there is one image in which a defect is merely visualized to an extent similar to an extent of variations in pixel values included in a non-defective product image, the feature amount does not have to be selected from the one image as long as there is another image in which the defect is clearly visualized, and thus a redundant feature amount will not be selected. Therefore, it is possible to achieve highly precise separation performance. Further, the inspection should be executed only one time because only one selection result of the feature amount is acquired by combining the feature amounts.

As described above, in the present exemplary embodiment, a plurality of feature amounts is extracted from at least each of two images based on images captured under at least two or more different illumination conditions with respect to a target object having a known defective or non-defective appearance. Then, a feature amount for determining whether a target object is defective or non-defective is selected from feature amounts that comprehensively include the feature amounts extracted from the images, and a classifier for determining whether a target object is defective or non-defective is generated based on the selected feature amount. Then, whether the appearance of the target object is defective or non-defective is determined based on the feature amount extracted from the inspection image and the classifier. Accordingly, when the images of the target object are captured under a plurality of illumination conditions, a learning target image does not have to be selected for each illumination condition, and thus the inspection can be executed at one time with respect to the plurality of illumination conditions. Further, it is possible to determine with high efficiency whether the inspection target object is defective or non-defective because a redundant feature amount will not be selected. Therefore, it is possible to determine with a high degree of precision whether the appearance of the inspection target object is defective or non-defective within a short period of time.

Further, in the present exemplary embodiment, an exemplary embodiment in which learning and inspection are executed by the same apparatus (defective/non-defective determination apparatus 200) has been described as an example. However, the learning and the inspection do not always have to be executed in the same apparatus. For example, a classifier generation apparatus for generating (learning) a classifier and an inspection apparatus for executing inspection may be configured, so that a learning function and an inspection function are realized in the separate apparatuses. In this case, for example, respective functions of the image acquisition unit 201 to the classifier saving unit 208 are included in the classifier generation apparatus, whereas respective functions of the image acquisition unit 201, the image composition unit 202, and the selected feature amount extraction unit 209 to the output unit 211 are included in the inspection apparatus. At this time, the classifier generation apparatus and the inspection apparatus directly communicate with each other, so that the inspection apparatus can acquire the information about a classifier and a feature amount. Further, instead of the above configuration, for example, the classifier generation apparatus may store the information about a classifier and a feature amount in a portable storage medium, so that the inspection apparatus may acquire the information about a classifier and a feature amount by reading the information from that storage medium.

Next, a second exemplary embodiment will be described. In the first exemplary embodiment, description has been given with respect to an exemplary embodiment in which learning and inspection are executed by using the image data captured under at least two different illumination conditions. In the present exemplary embodiment, description will be given with respect to an exemplary embodiment in which learning and inspection are executed by using the image data captured by at least two different imaging unit. Thus, because learning data of different types are used in the first and the present exemplary embodiments, configurations and processing thereof are mainly different in this regard. Accordingly, in the present exemplary embodiment, reference numerals the same as those applied in FIG. 1 to FIG. 14A (14B) are applied to the portions similar to those described in the first exemplary embodiment, and detailed descriptions thereof will be omitted.

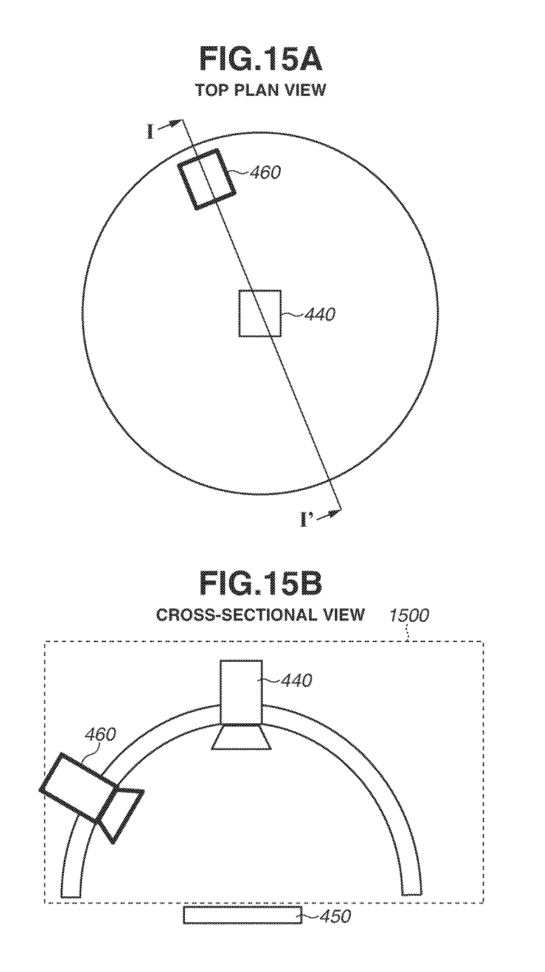

FIG. 15A is a diagram illustrating a top plan view of an imaging apparatus 1500, and FIG. 15B is a diagram illustrating a cross-sectional view of the imaging apparatus 1500 (surrounded by a dotted line in FIG. 15B) and a target object 450 according to the present exemplary embodiment. FIG. 15B is a cross sectional view taken along a line I-I′ in FIG. 15A.

As illustrated in FIG. 15B, although the imaging apparatus 1500 according to the present exemplary embodiment is similar to the imaging apparatus 220 described in the first exemplary embodiment, the imaging apparatus 1500 is different in that another camera 460 (expressed by a thick line in FIG. 15B) different from the camera 440 is included in addition to the camera 440. An optical axis of the camera 440 is set in a vertical direction with respect to a plate face of the target object 450. On the other hand, an optical axis of the camera 460 is inclined toward the plate face of the target object 450 and in a direction vertical to the plate face. Further, the imaging apparatus 1500 according to the present exemplary embodiment does not have an illumination. In the first exemplary embodiment, feature amounts acquired from image data captured under at least two different illumination conditions have been combined. On the other hand, in the present exemplary embodiment, feature amounts acquired from image data captured by at least two different imaging unit (cameras 440 and 460) are combined. Although two cameras 440 and 460 are illustrated in FIG. 15A (15B), the number of cameras may be three or more as long as a plurality of cameras is used.

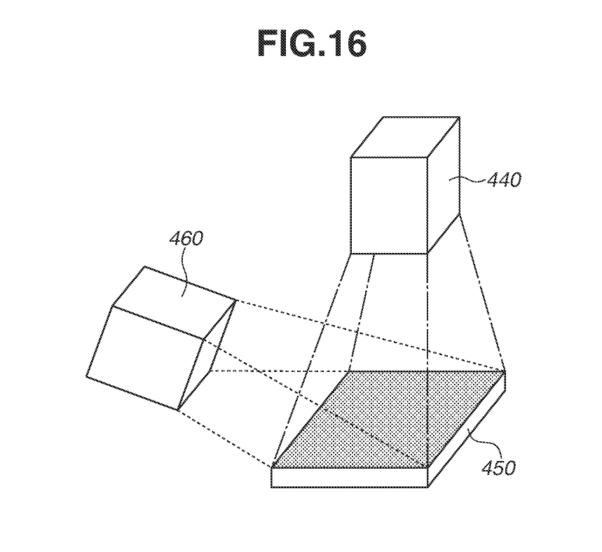

FIG. 16 is a diagram illustrating a state where the cameras 440, 460, and the target object 450 illustrated in FIG. 15A (15B) are viewed from the above in three dimensions. Images of the same region of the target object 450 are captured by the two cameras 440 and 460 in mutually different imaging directions, and image data are acquired therefrom. Using a plurality of different cameras is advantageous in that even a defect that is hardly visualized can be likely captured by either of the cameras by acquiring the image data in a plurality of image-forming directions with respect to the target object 450. This is similar to the idea described with respect to the plurality of illumination conditions, and as with the case of a defect easily visualized under the illumination conditions illustrated in FIG. 6, there is also a defect easily visualized depending on an imaging direction (optical axis) of the imaging unit with respect to the target object 450.

The processing flows of the defective/non-defective determination apparatus 200 in the learning and inspection periods are similar to those of the first exemplary embodiment. However, in the first exemplary embodiment, in step S102, images of the one target object 450 illuminated under a plurality of illumination conditions are acquired. On the other hand, in the present exemplary embodiment, images of the one target object 450 captured by a plurality of imaging units in different imaging directions are acquired. Specifically, an image of the target object 450 captured by the camera 440 and an image of the target object 450 captured by the camera 460 are acquired.

Further, in step S105, the feature amounts are comprehensively and respectively extracted from the two images acquired by the cameras 440 and 460, and these feature amounts are combined in step S107. Thereafter, the feature amounts are selected in step S109. It should be noted that, in step S104, the images may be synthesized according to the imaging directions (optical axes) of the cameras 440 and 460. The processing flow of the defective/non-defective determination apparatus 200 in the inspection period is also similar to that described above, and thus detailed description thereof will be omitted. As a result, similar to the first exemplary embodiment, a learning target image does not have to be selected with respect to the images acquired by each of the imaging units, and thus the inspection can be executed at one time with respect to the images captured by the plurality of imaging units. Further, it is possible to highly efficiently determine whether the inspection target object is defective or non-defective because a redundant feature amount will not be selected.

Furthermore, in the present exemplary embodiment, various modification examples described in the first exemplary embodiment can be also employed. For example, similar to the first exemplary embodiment, images may be captured by at least two different imaging units under at least two or more illumination conditions with respect to the one target image 450. Specifically, the illuminations 410a to 410h, 420a to 420h, and 430a to 430h are similarly arranged as illustrated in FIG. 4A (4B) described in the first exemplary embodiment, and images can be captured by a plurality of imaging units under a plurality of illumination conditions by changing the irradiation directions and the light amounts of respective illuminations. Then, the images may be captured by at least two different imaging units under respective illumination conditions. The learning target image does not have to be selected under each illumination condition. In addition, image selection becomes unnecessary for each imaging unit, and inspection can be executed at one time with respect to the plurality of imaging units and the plurality of illumination conditions.

Next, a third exemplary embodiment will be described. In the first exemplary embodiment, description has been given with respect to an exemplary embodiment in which learning and inspection are executed by using the image data captured under at least two different illumination conditions. In the present exemplary embodiment, description will be given with respect to an exemplary embodiment in which learning and inspection are executed by using the image data of at least two different regions in a same image. Therefore, because learning data of different types are used in the first and the present exemplary embodiments, configurations and processing thereof are mainly different in this regard. Accordingly, in the present exemplary embodiment, reference numerals the same as those applied in FIG. 1 to FIG. 14A (14B) are applied to the portions similar to those described in the first exemplary embodiment, and detailed descriptions thereof will be omitted.

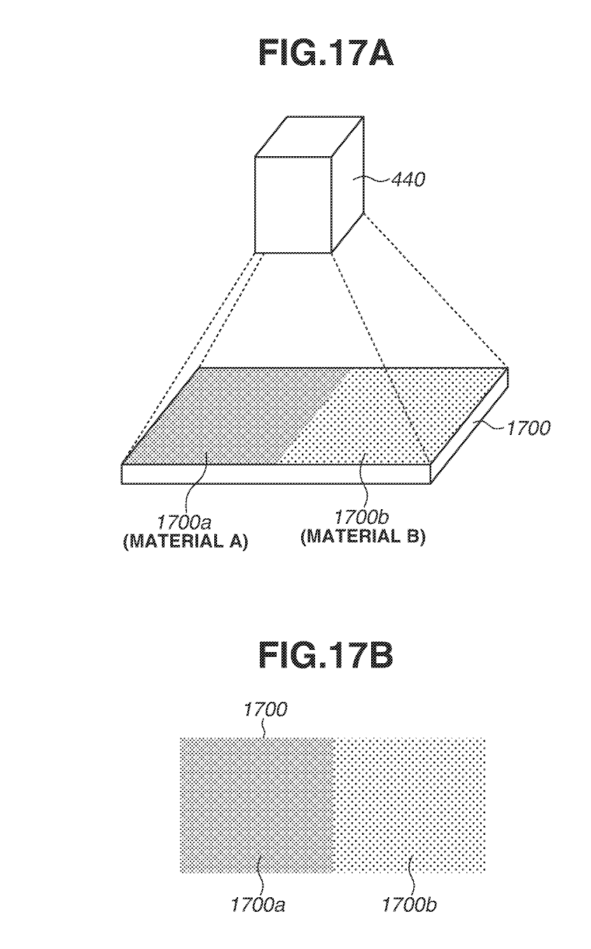

FIG. 17A is a diagram illustrating a state where the camera 440 and a target object 1700 are viewed from the above in three dimensions, whereas FIG. 17B is a diagram illustrating an example of a captured image of the target object 1700. Further, the target object 1700 illustrated in FIG. 17A (17B) is configured of two materials although the target object 450 described in the first exemplary embodiment is configured of the same material. In FIG. 17A (17B), a material of the region 1700a is referred to as a material A, whereas a material of the region 1700b is referred to as a material B.

In the first exemplary embodiment, the feature amounts acquired from the image data captured under at least two different illumination conditions have been combined. On the other hand, in the present exemplary embodiment, feature amounts acquired from the image data of different regions in the same image captured by the camera 440 are combined. In the example illustrated in FIG. 17B, two regions i.e., the region 1700a corresponding to the material A and the region 1700b corresponding to the material B are specified as inspection regions. Although two inspection regions are illustrated in FIG. 17A (17B), the number of inspection regions may be three or more as long as a plurality of regions is specified.

The processing flows of the defective/non-defective determination apparatus 200 in the learning and inspection periods are similar to those of the first exemplary embodiment. However, in the present exemplary embodiment, in step S102, an image of two regions 1700a and 1700b of the same target object 1700 is acquired. Further, in step S105, feature amounts are comprehensively and respectively extracted from the image of the two regions 1700a and 1700b, and these feature amounts are combined in step S107. It should be noted that, in step S104, the images may be synthesized according to the regions. The processing flow of the defective/non-defective determination apparatus 200 in the inspection period is also similar to that described above, and thus detailed description thereof will be omitted. Conventionally, it has been necessary to respectively execute learning and inspection twice because learning results have been acquired with respect to the regions 1700a and 1700b independently. On the contrary, the present exemplary embodiment is advantageous in that both of learning and inspection should be executed only one time. Furthermore, in the present exemplary embodiment, various modification examples described in the first exemplary embodiment can be also employed.

Next, a fourth exemplary embodiment will be described. In the first exemplary embodiment, description has been given with respect to an exemplary embodiment in which learning and inspection are executed by using the image data captured under at least two different illumination conditions. In the present exemplary embodiment, description will be given with respect to an exemplary embodiment in which learning and inspection are executed by using image data of at least two different portions of the same target object. As described above, because learning data of different types are used in the first and the present exemplary embodiments, configurations and processing thereof are mainly different in this regard. Accordingly, in the present exemplary embodiment, reference numerals the same as those applied in FIG. 1 to FIG. 14A (14B) are applied to the portions similar to those described in the first exemplary embodiment, and detailed descriptions thereof will be omitted.

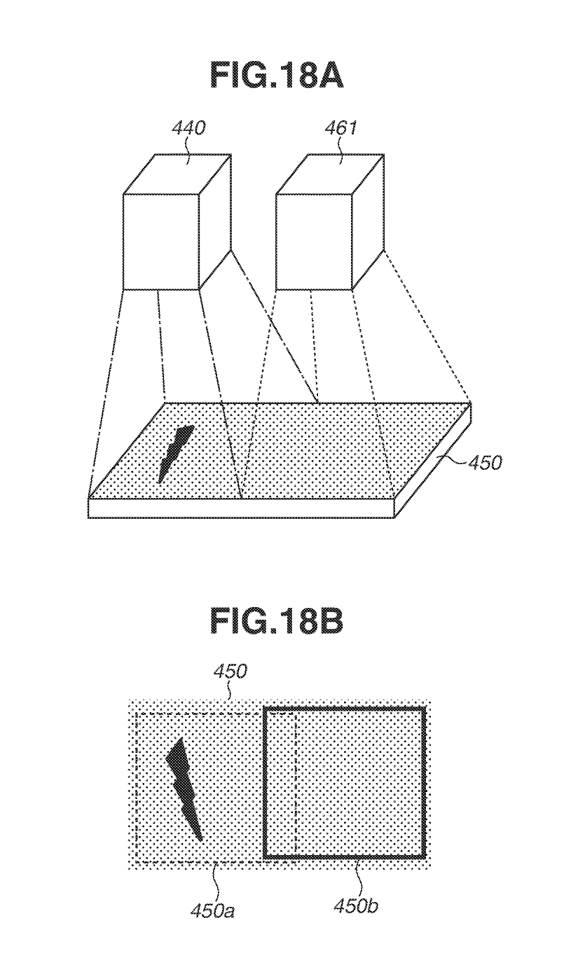

FIG. 18A is a diagram illustrating a state where cameras 440, 461, and a target object 450 are viewed from the above in three dimensions, whereas FIG. 18B is a diagram illustrating an example of a captured image of the target object 450. Although the imaging apparatus according to the present exemplary embodiment is similar to the imaging apparatus 220 described in the first exemplary embodiment, the imaging apparatus is different in that another camera 461 different from the camera 440 is included in addition to the camera 440. An optical axis of each of the cameras 440 and 461 is set in a direction vertical to a plate face of the target object 450. The cameras 440 and 461 capture images of different regions of the target object 450. For the sake of processing described below, in FIG. 18A (18B), a defect is intentionally illustrated in the left-side portion of the target object 450. Further, although two cameras 440 and 461 are illustrated in FIG. 18A, the number of cameras may be three or more as long as a plurality of cameras is used. Further, the target object 450 illustrated in FIG. 18A (18B) is formed of a same material.

In the present exemplary embodiment, in step S105, the feature amounts are comprehensively and respectively extracted from image data of different portions of the same target object 450, and these feature amounts are combined in step S107. Specifically, the camera 440 disposed on the left side in FIG. 18A captures an image of a left-side region 450a of the target object 450, whereas the camera 461 disposed on the right side captures an image of a right-side region 450b of the target object 450. Thereafter, feature amounts comprehensively extracted from the left-side region 450a and the right-side region 450b of the target object 450 are combined together. It should be noted that, in step S104, the images may be synthesized according to the regions. The processing flow of the defective/non-defective determination apparatus 200 in the inspection period is also similar to that described above, and thus detailed description thereof will be omitted.

In addition to the advantageous point as described in the third exemplary embodiment that the number of times of learning and inspection can be reduced, the present exemplary embodiment is advantageous in that non-defective and defective learning products can be labeled easily. Hereinafter, this advantageous point will be described in detail.

As illustrated in FIG. 18B, for example, an image of the region 450a captured by the left-side camera 440 includes a defect whereas an image of the region 450b captured by the right-side camera 461 does not include the defect. Further, in the example illustrated in FIG. 18B, although the regions 450a and 450b partially overlap with each other, the regions 450a and 450b do not have to overlap with each other.

Now, non-defective and defective products will be learned as described in detail in the first exemplary embodiment. If an idea of combining the feature amounts is not introduced, learning has to be executed with respect to each of the regions 450a and 450b. It is obvious that the target object 450 illustrated in FIG. 18B is a defective product as there is a defect in the target object 450. However, the target object 450 is treated as a defective object in the learning period of the region 450a while being treated as a non-defective product in the learning period of the region 450b. Therefore, there is a case where a label that is to be applied to the target object 450 itself may be different from the non-defective or defective label in the leaning period.

However, by combining the feature amounts of the regions 450a and 450b as described in the present exemplary embodiment, the non-defective or defective label does not have to be changed for each of the regions 450a and 450b. Therefore, usability in the leaning period can be substantially improved.

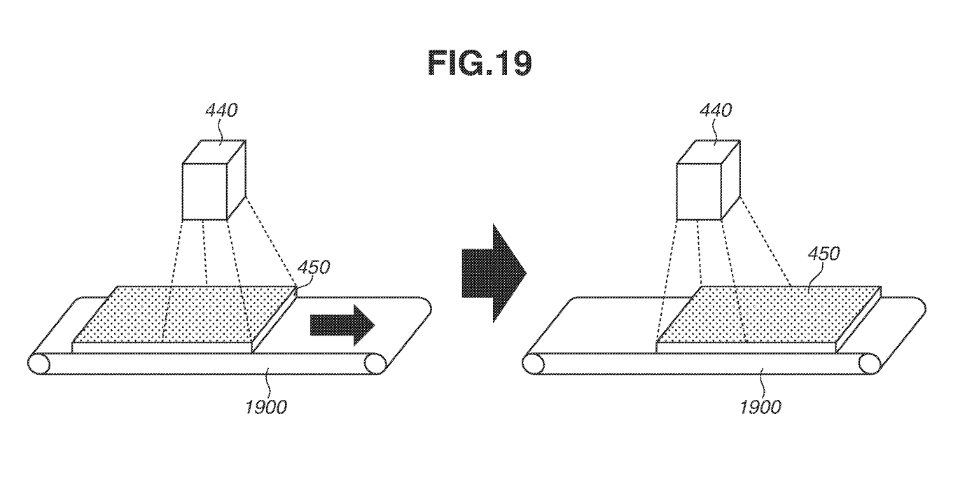

Next, a modification example of the present exemplary embodiment will be described. FIG. 19 is a modification example illustrating a state where the camera 440 and the target object 450 are viewed from the above in three dimensions. Further, although the target object 450 is not movable in the first exemplary embodiment, in the present exemplary embodiment, the target object 450 is mounted on a driving stage 1900. In the modification example according to the present exemplary embodiment, as illustrated in a left-side diagram in FIG. 19, an image of a right-side region of the target object 450 is captured by the camera 440. Then, the target object 450 is moved by the driving stage 1900, so that an image of a left-side region of the target object 450 is captured by the camera 440 as illustrated in a right-side diagram in FIG. 19. Thereafter, feature amounts comprehensively extracted from the right-side region and the left-side region of the target object 450 are combined together. In the example illustrated in FIG. 19, by driving the stage 1900, images of different portions of the same target objet 450 are captured by the camera 440. However, as long at least any one of the camera 440 and the target object 450 is moved to cause the camera 440 to capture the images of different portions of the target object 450, the apparatus does not always have to be configured in such a manner. For example, the camera 440 may be moved while the target object 450 is fixed.

### Other Exemplary Embodiment

The above-described exemplary embodiments are merely examples embodying aspects of the present invention, and are not be construed as limiting the technical range of aspects of the present invention. Accordingly, the aspects of present invention can be realized in diverse ways without departing from the scope of the technical spirit or main features of aspects of the present invention.

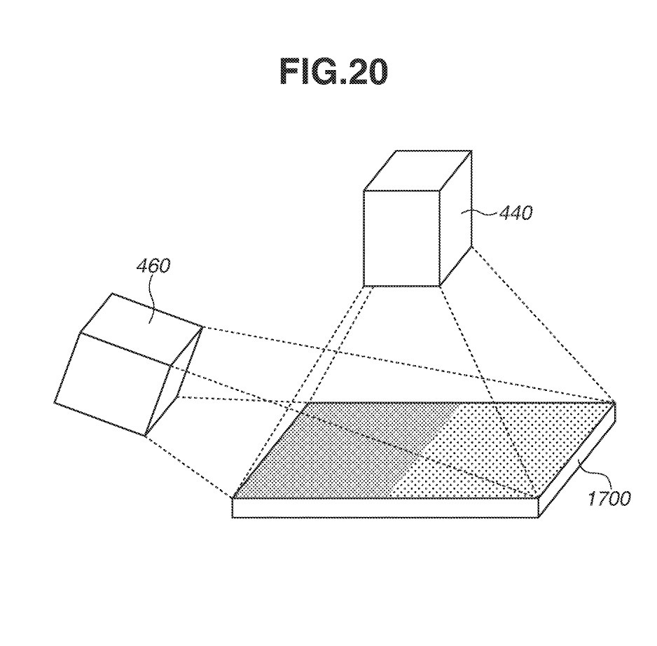

For example, for the sake of simplicity, the first to the fourth exemplary embodiments have been described as independent embodiments. However, at least two exemplary embodiments from among these exemplary embodiments can be combined. A specific example will be illustrated in FIG. 20. Similar to the third exemplary embodiment, FIG. 20 is a diagram illustrating a state where a target object 1700 having different materials is captured by two cameras 440 and 460. The arrangement of the cameras 440 and 460 is the same as the arrangement illustrated in FIG. 16 described in the second exemplary embodiment. As described above, the configuration illustrated in FIG. 20 is a combination of the second and the third exemplary embodiments, and thus the feature amounts of four regions are combined. Specifically, two feature amounts extracted from the right-side region and the left-side region of the target object 1700 captured by the camera 440 and two feature amounts extracted from the right-side region and the left-side region of the target object 1700 captured by the camera 460 are combined together. Furthermore, the number of pieces of image data for comprehensively extracting the feature amounts may be increased by changing the illumination conditions described in the first exemplary embodiment (i.e., an employable illumination, an amount of illumination light, or exposure time). Further, in the present exemplary embodiment, all of feature amounts in the four regions are combined. However, the feature amounts to be combined may be changed according to a degree of the precision of separation performance or inspection precision required by the user, and thus feature amounts of only three regions, for example, may be combined.

Further, aspects of the present invention can be realized by executing the following processing. Software (computer program) for realizing the function of the above-described exemplary embodiment is supplied to a system or an apparatus via a network or various storage media. Then, a computer (or a CPU or a micro processing unit (MPU)) of the system or the apparatus reads and executes the computer program.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While aspects of the present invention have been described with reference to exemplary embodiments, it is to be understood that the aspects of the invention are not limited to the disclosed exemplary embodiments. The scope of the following claims is to be accorded the broadest interpretation so as to encompass all such modifications and equivalent structures and functions.

This application claims the benefit of Japanese Patent Application No. 2015-174899, filed Sep. 4, 2015, and No. 2016-064128, filed Mar. 28, 2016, which are hereby incorporated by reference herein in their entirety.

What is claimed is:

1. A classifier generation apparatus comprising:
a learning extraction unit configured to extract feature amounts from each of at least two images based on images captured under at least two different imaging conditions with respect to a target object having a known defective or non-defective appearance;
a selection unit configured to select a feature amount for determining whether a target object is defective or non-defective from among the extracted feature amounts; and
a generation unit configured to generate a classifier for determining whether a target object is defective or non-defective based on the selected feature amount.

2. The classifier generation apparatus according to claim 1 further comprising:
a composition unit configured to composite a plurality of images captured under at least two different imaging conditions with respect to the target object having the known defective or non-defective appearance,
wherein at least two images based on the captured images include at least any one of a composite image created by the composition unit and an image not selected as a composition target of the composition unit of the captured images.

3. The classifier generation apparatus according to claim 2, wherein the composition unit executes an operation to composite the images by using a pixel value of each of images captured under at least two different imaging conditions with respect to a target object having a known defective or non-defective appearance, a statistics amount of the images, and a statistics amount between the plurality of the images.

4. The classifier generation apparatus according to claim 1, wherein the learning extraction unit generates a plurality of images in different frequencies from each of at least two images based on the captured images with respect to the target object having the known defective or non-defective appearance, and extracts a feature amount from each of the generated images in different frequencies.

5. The classifier generation apparatus according to claim 4, wherein the learning extraction unit generates the plurality of images in different frequencies using wavelet transformation or Fourier transformation.

6. The classifier generation apparatus according to claim 4, wherein the learning extraction unit extracts the feature amounts by executing at least any one of statistical operation, convolution operation, differentiation operation, or binarization processing with respect to the plurality of images in different frequencies.

7. The classifier generation apparatus according to claim 1, wherein the selection unit calculates an evaluation value with respect to each of the feature amounts that comprehensively include the feature amounts extracted by the learning extraction unit or an evaluation value with respect to a combination of feature amounts that comprehensively include the feature amounts extracted by the learning extraction unit, ranks each of the feature amounts that comprehensively include the feature amounts extracted by the learning extraction unit, or each of the combination of feature amounts that comprehensively include the feature amounts extracted by the learning extraction unit based on the calculated evaluation value, and selects a feature amount for determining whether the target object is defective or non-defective according to the ranking.

8. The classifier generation apparatus according to claim 7, wherein, with respect to each of the target objects having known defective or non-defective appearances, the selection unit calculates a score including a number of feature amounts for determining whether the target object is defective or non-defective as a parameter, arranges each of the target objects having known defective or non-defective appearances in an order of the score according to the number of feature amounts, evaluates an arrangement order of the arranged target objects based on whether the target objects have defective or non-defective appearances, derives a number of feature amounts to be selected as feature amounts for determining whether the target object is defective or non-defective based on a result of the evaluation, and selects feature amounts that comprehensively include the feature amounts extracted by the learning extraction unit or combinations of feature amounts that comprehensively include the feature amounts extracted by the learning extraction unit as many as the derived number from a highest order in the ranking.

9. The classifier generation apparatus according to claim 1, wherein at least the two different imaging conditions includes at least any one of imaging under at least two different illumination conditions, imaging under at least two different imaging directions, or imaging at least two different regions of the target object.

10. The classifier generation apparatus according to claim 9, wherein the illumination conditions include at least any one of an illumination light amount with respect to the target object, an irradiation direction of illumination with respect to the target object, or exposure time of an image sensor for executing the imaging.

11. A method comprising:
extracting feature amounts from each of at least two images based on images captured under at least two different imaging conditions with respect to a target object having a known defective or non-defective appearance;
selecting a feature amount for determining whether a target object is defective or non-defective from among the extracted feature amounts;
generating a classifier for determining whether a target object is defective or non-defective based on the selected feature amount extracting, through inspection extraction, a plurality of feature amounts from each of at least two images based on images captured under imaging conditions same as the imaging conditions, with respect to a target object having an unknown defective or non-defective appearance; and
determining whether an appearance of the target object is defective or non-defective based on the feature amounts extracted through the inspection extraction and the generated classifier.

12. A non-transitory computer-readable storage medium storing computer executable instructions that cause a computer to execute a classifier generation method, the classifier generation method comprising:
extracting feature amounts from each of at least two images based on images captured under at least two different imaging conditions with respect to a target object having a known defective or non-defective appearance;
selecting a feature amount for determining whether a target object is defective or non-defective from among the extracted feature amounts; and
generating a classifier for determining whether a target object is defective or non-defective based on the selected feature amount.

13. A defective/non-defective determination apparatus comprising:
a learning extraction unit configured to extract feature amounts from each of at least two images based on images captured under at least two different imaging conditions with respect to a target object having a known defective or non-defective appearance;
a selection unit configured to select a feature amount for determining whether a target object is defective or non-defective from among the extracted feature amounts;
a generation unit configured to generate a classifier for determining whether a target object is defective or non-defective based on the selected feature amount;
an inspection extraction unit configured to extract feature amounts from each of at least two images based on images captured under the at least two different imaging conditions with respect to a target object having an unknown defective or non-defective appearance; and
a determination unit configured to determine whether an appearance of the target object is defective or non-defective by comparing the extracted feature amounts with the generated classifier.

14. A method comprising:
extracting feature amounts from each of at least two images based on images captured under at least two different imaging conditions with respect to a target object having a known defective or non-defective appearance;
selecting a feature amount for determining whether a target object is defective or non-defective from among the extracted feature amounts;
generating a classifier for determining whether a target object is defective or non-defective based on the selected feature amount
extracting, through inspection extraction, a plurality of feature amounts from each of at least two images based on images captured under imaging conditions same as the imaging conditions, with respect to a target object having an unknown defective or non-defective appearance; and
determining whether an appearance of the target object is defective or non-defective based on the feature amounts extracted through the inspection extraction and the generated classifier.

15. A computer-readable storage medium storing computer executable instructions that cause a computer to execute an inspection method, the inspection method comprising:
extracting feature amounts from each of at least two images based on images captured under at least two different imaging conditions with respect to a target object having a known defective or non-defective appearance;
selecting a feature amount for determining whether a target object is defective or non-defective from among the extracted feature amounts;
generating a classifier for determining whether a target object is defective or non-defective based on the selected feature amount
extracting, through inspection extraction, a plurality of feature amounts from each of at least two images based on images captured under imaging conditions same as the imaging conditions, with respect to a target object having an unknown defective or non-defective appearance; and
determining whether an appearance of the target object is defective or non-defective based on the feature amounts extracted through the inspection extraction and the generated classifier.
